(19) United States
(12) Patent Application Publication
(10) Pub. No.: US 2003/0211270 A1
(43) Pub. Date: Nov. 13, 2003

(54) Pressure sensitive food grade wrap film and process for manufacturing such a film

(75) Inventors: Kent B. McReynolds, Racine, WI (US); Kenneth A. Toney, Baton Rouge, LA (US); John O. McCree, Bay City, MI (US); John S. Sabol JR., Sanford, MI (US); Paul A. Kolosowski, Franksville, WI (US); Michael J. Rohrer, Racine, WI (US); James H. Duvall, Mentor, OH (US); Robert M. Shaw JR., Kirtland, OH (US)

Correspondence Address: S.C. JOHNSON & SON, INC., 1525 HOWE STREET, RACINE, WI, 53403-2236, US

(73) Assignee: S.C. Johnson Home Storage, Inc., Racine, WI

(21) Appl. No.: 10/405,885

(22) Filed: Apr. 3, 2003

Related U.S. Application Data
(62) Division of application No. 09/907,991, filed on Jul. 18, 2001.
(60) Provisional application No. 60/247,986, filed on Nov. 14, 2000.
(60) Provisional application No. 60/220,196, filed on Jul. 24, 2000.

(51) Int. Cl. B32B 9/00; B32B 33/00

(52) U.S. Cl. 428/40.1

(57) ABSTRACT

A flexible pressure-sensitive food grade wrap film, and a process for manufacturing the film. The film includes a substrate overcoated with a pressure-sensitive adhesive, a release overprinted on the adhesive that prevents the adhesive from clinging to the surface of an article or to itself without applying pressure, and, optionally, a release coating on the opposite side of the substrate. Once pressure is applied to the film, the film flexibility allows the adhesive to contact the surface of the article or itself and subsequently adhere to hold the film in place or to form a sealed pouch around an article. The pressure-activated contact and adhesion to an article or to itself are designed to form a tight, spill-resistant physical bond that seals liquid or solid contents in a container, or forms a sealed pouch around a solid article.

### FIELD OF THE INVENTION

This invention relates to flexible films that can be used to package food. In particular, this invention relates to an improved pressure sensitive food grade wrap film that does not unduly stick to itself but is sufficiently tacky to seal around a package.

### BACKGROUND OF THE INVENTION

Flexible films for use as food wraps have been developed and improved over time. Such food wraps are typically called food grade wrap films. There are many criteria that consumers require in a flexible food grade wrap film. First, it is important for the film to be strong and yet easily torn when brought in contact with a cutter bar as found in the standard containers used for containing and dispensing flexible food grade wrap film. Second, it is important for the film to be flexible so that it molds easily around a container or object to be covered or wrapped. Third, the film must be somewhat tacky to seal around the container or object, but at the same time not be so tacky that it will too aggressively stick to itself, making the film difficult to unwind from a roll due to “blocking”, or too unruly making it difficult to place the film at a desired location during use.

For general background, U.S. Pat. No. 5,399,426 (Koch, et al.) discloses monolayer and multilayer film structures having at least one layer of a polymer blend comprising at least one branched polymer (e.g., low density polyethylene (LDPE) or ethylene/vinyl acetate copolymer (EVA)) and at least one linear polyethylene (e.g., LLDPE). The film structures are described as having a good overall balance of properties, including high ultimate elongation, excellent load retention and good machine direction tear. However, no mention is made of any particular feature in the film that addresses the concern that the film not be so tacky that it will easily stick to itself, causing “blocking” when wound or preventing easy placement of the film in a desired location.

U.S. Pat. No. 5,965,235 (McGuire, et al.) teaches a three-dimensional sheet material. A plurality of protrusions extends outwardly from one side of the material, creating depressions at corresponding locations on the other side. The depressions can be filled with a substance such as an adhesive. In order to prevent nesting, the plurality of protrusions forms an amorphous pattern of various two-dimensional shapes having a statistically-controlled degree of randomness.

U.S. Pat. No. 5,662,758 (Hamilton, et al.) relates to a method for making a flexible film having protrusions formed on an adhesive side which act to space a pressure sensitive adhesive from a target surface until the film is pressed thereagainst. The method for making this flexible film requires coating a forming screen with an interconnected layer of pressure sensitive adhesive and places a piece of flexible film in contact with the layer of adhesive. The layer of adhesive preferentially adheres to the piece of flexible film. Furthermore, since the forming screen has a plurality of recesses therein, the coating step applies the layer of adhesive without bridging the recesses. Another step in the method forms the piece of flexible film to create a plurality of protrusions extending into the recesses. The plurality of protrusions end up being registered with the interconnected layer of pressure sensitive adhesive by virtue of using the same screen to transfer adhesive and to form the protrusions.

Although the McGuire, et al. patent may disclose a sheet material that prevents nesting, the disclosed material must be provided with a complicated pattern of three-dimensional features. The Hamilton, et al. patent also contemplates a film with three-dimensional features (i.e., a film that has protrusions and recesses produced by a forming screen). The three-dimensional features in each of these patents reduce the gloss and transparency of the sheet material, both of which we believe are preferred by consumers.

International Publication No. WO 01/23490 A1 (Bonke, et al.) relates to a cling wrap made of a first surface having an embossed area, including a plurality of protrusions therefrom forming a plurality of raised contact surfaces and a base surface, wherein the total surface area of the raised contact surfaces makes up less than about 10% of the total surface area of the embossed area. An adhesive is applied to cover at least 80% of the embossed area. The cling wrap is acceptable for direct food contact and is sufficiently heat resistant for microwave re-heating. However, since the cling wrap disclosed in the Bonke, et al. patent document also is embossed, it has similar problems with lack of transparency to those considered above as regards the McGuire, et al. and Hamilton, et al. patents.

U.S. Patent No. 6,194,062 B1 (Hamilton, et al.) is related to U.S. Pat. No. 5,662,758 (Hamilton, et al.) discussed above, and generally discloses sheet-like materials suitable for use in the containment and protection of various items, including the preservation of perishable materials such as food items. This storage wrap material has a first side and a second side, the first side comprising an active side exhibiting an adhesion peel force after activation by a user that is greater than an adhesion peel force exhibited prior to activation by a user. The use of an adhesive or adhesive-like substance on the surface of the material provides an adhesion peel force after activation that is sufficient to form a barrier seal against a target surface at least as great as those of the material and the target surface such that perishable items, such as food items, may be effectively preserved.

Finally, U.S. Pat. No. 5,948,493 (Groeger) is also directed to a plastic wrap but this wrap exhibits little or no cling until such time as it is applied to an article or other target surface. An adhesive layer formed on one side of the sheet of olefinic polymer is exposed to a treatment that superficially oxidizes or cross-links the outer layer of the adhesive material to form a film that exhibits greatly attenuated adhesion. This cross-linked outer layer is disruptable as the wrap is applied and stretched or otherwise deformed in a manner that uncovers the adhesive material and endows cling properties on at least localized areas of the wrap. Techniques for treating the adhesive layer include UV irradiation, exposure to corona, and ozonification. Consequently, if the outer layer is not disrupted, the Groeger plastic wrap is not tacky.

We have discovered an alternative, cost-effective structure for a food grade film wrap (and a method for making it) containing a pressure sensitive adhesive (PSA) in combination with other film features, that is flexible, preferably transparent, strong yet easily torn off from the roll using a cutter bar, and that is sufficiently tacky to seal around a container or object but not too tacky to cause “blocking”. Furthermore, the food grade film wrap that we have developed can be pressed or sealed into place without excessive amounts of force or without having to stretch it, for example, to activate it, making this product easy to use. Our method of making such a film is efficient and cost-effective.

In areas of product manufacture outside of the plastic film wrap area, PSAs have been used to make a surface of a product non-sticky at the outset, but capable of adhesion to another surface upon the application of pressure to the adhesive.

U.S. Pat. No. 3,301,741 (Henrickson, et al.) discloses an adhesive coating that is pressure-sensitive and capable of forming a strong adhesive bond with a substrate surface upon being pressed against under moderate hand pressure, but which on light contact with the surface remains unbonded thereto and may be easily moved to the desired position. This is achieved by creating an adhesive surface having thereon raised protrusions that are rendered non-adhesive. The adhesive surface is initially covered by a carrier that includes indentations (in which the protrusions are formed in the disclosed formation process). Once the carrier is removed and the adhesive surface is placed against a target surface, the application of pressure disrupts the non-adhesive tips and displaces the protrusions, thereby permitting adhesive bonding between the adhesive surface and the target surface. Henrickson, et al. contemplates that such PSAs could be used for wall coverings, sign-boards, and adhesion of materials to metal objects.

Along the same lines, U.S. Pat. No. 3,554,835 (Morgan) and related U.S. Pat. No. 3,592,722 (Morgan) teach a slidable adhesive laminate composed of several distinct layers including a PSA layer, and release dots composed of silicone or like conventional release materials, that is exposed only when a backing layer is removed. When force is exerted on the film laminate, the adhesive extrudes from below the dots of the release material and adheres to the receptive surface, or the dots of release material may be fractured to expose the adhesive, or the dots of release material sink into the PSA allowing the adhesive to come in close contact with the adhesive receptive surface.

U.S. Pat. No. 4,376,151 (Parrotta) pertains to adhesive compositions for paper and business forms. Parrotta discloses a substrate having thereon a PSA and a top layer of microspheres, which are preferably hollow, in an amount sufficient to cover the adhesive layer. When sufficient pressure is applied, the microspheres are displaced and the adhesive is exposed. This adhesive composition is preferably manufactured by preparing a suspension of the microspheres in an adhesive composition, coating the suspension on the substrate and promoting the microspheres to migrate to the top of the suspension and form the top microsphere layer.

U.S. Pat. No. 5,141,790 (Calhoun, et al.) teaches a PSA tape or sheet that, once separated from a carrier web, is reliably repositionable by having a plurality of spaced clumps of particles uniformly distributed over at least one surface of the PSA, with the tips of the clumps of particles being substantially free from adhesive. The preferred particles are glass beads, 5 to 15 μm in diameter with the thickness of the PSA being about 26 μm. Each clump preferably contains about 5 to 100 particles. The Calhoun, et al. tape is said to be useful in making road signs and for applying objects to vehicles for purposes of information and/or decoration.

U.S. Pat. No. 4,556,595 (Ochi) recognizes that PSAs are used in signboards, decorative and display applications in automobiles and buildings, and fleet marking of automobiles and containers. Ochi teaches a PSA sheet structure having relocatable properties and composed of a PSA layer and non-adhesive solid particles, wherein the particles have an average diameter (<10μ) smaller than the thickness of the adhesive layer and are randomly but uniformly distributed over the surface of the adhesive layer, or are randomly but uniformly distributed and partially or fully embedded in the surface of the adhesive layer.

Similarly, U.S. Pat. No. 4,054,697 (Reed, et al.) teaches a decorative sheet material for applying to a wall, ceiling, floor, kitchen unit, table or other surface within domestic or industrial premises. The sheet material has a decorative surface and a working surface. The working surface has a continuous PSA coating on which is placed a discontinuous layer of resilient, non-adhesive particles that are deformed under a load to allow the PSA to stick to another surface. The particles can either be partially embedded or lie on the surface of the PSA.

U.S. Pat. No. 5,487,929 (Rusincovitch, Jr., et al.) also discloses a repositionable decorative sheet material that can be applied to a wall, ceiling, floor, kitchen unit, table or other surface within domestic and industrial premises. The working surface of the sheet material is provided with a discontinuous layer of PSA, and within the discontinuities is a pattern of non-adhesive projections having a height equal to or greater than the thickness of the adhesive.

U.S. Pat. No. 5,008,139 (Ochi, et al.) discloses a PSA structure that has a very low initial adhesion strength, and upon press-bonding, a very high final adhesion strength. Particles having a diameter of about 10 to 60 microns project from the surface of the PSA and either are solid or, if hollow, then non-rupturable by the pressure of bonding. Ochi, et al. contemplates that PSAs have wide applications in building materials such as wall paper, masking applications to temporarily mask parts in vehicles, and semipermanent markings on signboards and vehicles.

U.S. Pat. No. 6,004,308 (Haddock) teaches an adhesive attachment system with a non-tacky surface for sanitary napkins. The positioning adhesive has non-tacky irregularly shaped particles on its surface thereby rendering the adhesive non-tacky. Upon the application of pressure when attaching the napkin to the undergarment, the particles are rearranged and the adhesive is exposed to the undergarment.

U.S. Pat. No. 5,344,693 (Sanders) teaches a substrate covered with a PSA and non-deformable spacing means thereon that prevents unintentional contact between a PSA and another substance. Contact with the other substance can only occur by deforming the substrate and/or the other surface. The thickness or “height” of the PSA is less than the height of each spacing means. Such spacing means can be a pattern of non-adhesive, preferably thermoplastic or ink, and can be applied onto the PSA by means of a printing process. The spacers can also comprise expandable microspheres.

U.S. Pat. No. 4,904,092 (Campbell, et al.) relates to a continuous roll or stack of thermoplastic bags having improved openability. The bags feature an area of permanently tacky, pressure-sensitive adhesive that is applied to an outer surface of each bag. When a bag is pulled from the roll or stack, the adhesive temporarily adheres one side of the bag to the roll or stack, causing the front and back of the bag to separate slightly, thereby enhancing openability. Also disclosed are thermoplastic bags onto the surface of which an area of adhesive is applied in such a manner that the bags are self-closing when twisted shut in the area of the adhesive. However, the pressure-sensitive adhesive used covers only a narrow surface area since it is located only at the opening point of a bag, rather than over the entire surface of a plastic film wrap. Consequently, it is not clear whether the adhesive contemplated is safe for food contact, nor whether such narrow bands of adhesive are as flexible as an adhesive used in a plastic food wrap would have to be if the adhesive were to cover entire surfaces of the wrap.

Yet, none of these patents teaches the use of a PSA in a food grade wrap film to improve the features of the food grade wrap film, namely, preventing the film from sticking to itself (i.e., blocking) but at the same time ensuring that the film will stick to an object or container without having to apply excessive pressure to the film, once the consumer has identified the correct positioning of the film on the object or article. Developing an appropriate PSA system in a food grade wrap film introduces a particularly unique problem for two reasons. First, the Food and Drug Administration (FDA) and analogous agencies in other countries impose strict requirements on the types of chemicals that can come in contact with foods. Consequently, the choice of available materials to produce an improved food grade wrap film is limited. Second, food grade wrap film must be exceedingly thin and preferably translucent, more preferably transparent, introducing yet additional complications.

### SUMMARY OF THE INVENTION

Accordingly, it is an object of this invention to provide an improved food grade wrap film having the necessary strength and flexibility, that will not be prone to blocking, and at the same time that will provide a tight seal around covered objects and containers.

It is a further object of this invention to provide a pressure-sensitive food grade wrap film that satisfies all of the limitations as to materials that are imposed by the FDA, or similar agencies in other countries.

It is yet a further object of this invention to provide an improved food grade wrap film that can be produced economically and efficiently.

In one aspect, the present invention provides a food grade wrap film comprising: (a) a food grade substrate having an upper surface and a lower surface; (b) a food grade pressure-sensitive adhesive disposed on the upper surface of said substrate, and itself having an upper surface; and (c) a food grade release overprinted on the upper surface of the adhesive in a discontinuous and repeating pattern, such that the overprinted release on the adhesive creates a plurality of non-tacky peaks, and the absence of the overprinted release on the adhesive creates a plurality of valleys wherein the adhesive is exposed, the exposed adhesive in such valleys being protected by the peaks until such time as pressure is applied to the film.

In another aspect, the present invention provides a food grade wrap film comprising: (a) a food grade substrate having an upper surface and a lower surface, wherein the upper surface comprises an extruded pressure-sensitive adhesive layer that contains an amount of tackifier to render the extruded pressure-sensitive adhesive layer tacky; and (b) a food grade release overprinted on the upper surface of said substrate in a discontinuous and repeating pattern, such that said overprinted release on said substrate creates a plurality of non-tacky peaks and the absence of said overprinted release on said substrate creates a plurality of valleys wherein said substrate is exposed, said exposed substrate in such valleys being protected by the peaks until such time as pressure is applied to said film.

In yet another aspect, the present invention provides a food grade wrap film comprising: (a) a food-grade substrate having an upper surface, wherein the substrate contains an amount of a release agent; (b) a food grade pressure-sensitive adhesive disposed on the upper surface of said substrate, and itself having an upper surface; and (c) a food grade release overprinted on the upper surface of said adhesive in a discontinuous and repeating pattern, such that said overprinted release on said adhesive creates a plurality of non-tacky peaks and the absence of said overprinted release on said adhesive creates a plurality of valleys wherein the adhesive is exposed, the exposed adhesive in such valleys being protected by the peaks until such time as pressure is applied to the film.

In yet another aspect, the present invention provides a flexible, food grade wrap film comprising: (a) a flexible, food grade substrate having unitary upper and lower surfaces; (b) a flexible, food grade pressure-sensitive adhesive substantially continuously disposed on the entire upper surface of said substrate, and itself having a unitary upper surface; and (c) a flexible, food grade release overprinted on the upper surface of said adhesive in a discontinuous and repeating pattern, such that said overprinted release on said adhesive creates a plurality of non-tacky peaks and the absence of said overprinted release on said adhesive creates a plurality of valleys wherein the adhesive is exposed, the exposed adhesive in such valleys being protected by the peaks until such time as pressure is applied to said film.

In yet another aspect, the present invention provides a flexible, food grade wrap film comprising: (a) a flexible, food grade substrate having unitary upper and lower surfaces, wherein the upper surface comprises an extruded pressure-sensitive adhesive layer that contains an amount of tackifier to render the extruded pressure-sensitive adhesive layer tacky; and (b) a flexible, food grade release overprinted on the upper surface of said substrate in a discontinuous and repeating pattern, such that said overprinted release on said substrate creates a plurality of non-tacky peaks and the absence of said overprinted release on said substrate creates a plurality of valleys wherein said substrate is exposed, said exposed substrate in such valleys being protected by the peaks until such time as pressure is applied to said film.

In yet another aspect, the present invention provides a flexible, food grade wrap film comprising: (a) a flexible, food-grade substrate having unitary upper and lower surfaces, wherein the substrate contains an amount of a release agent; (b) a flexible food grade pressure-sensitive adhesive substantially continuously disposed on the entire upper surface of said substrate, and itself having a unitary upper surface; and (c) a flexible, food grade release overprinted on the upper surface of said adhesive in a discontinuous and repeating pattern, such that said overprinted release on said adhesive creates a plurality of non-tacky peaks and the absence of said overprinted release on said adhesive creates a plurality of valleys wherein the adhesive is exposed, the exposed adhesive in such valleys being protected by the peaks until such time as pressure is applied to the film.

In still another aspect, the present invention provides a process for manufacturing a food grade wrap film comprising: (a) producing a substrate having an upper surface and a lower surface; (b) applying a food-grade pressure sensitive adhesive to the upper surface of the substrate, and (c) overprinting a food-grade release onto the upper surface of the adhesive, wherein the release is overprinted in a discontinuous and repeating pattern, such that the overprinted release on the adhesive creates a plurality of non-tacky peaks and the absence of the overprinted release on the adhesive creates a plurality of valleys wherein the adhesive is exposed, the exposed adhesive in such valleys being protected by the peaks until such time as pressure is applied to said film during use.

In yet another aspect, the present invention provides a process for manufacturing a food grade wrap film comprising: (a) producing a substrate having an upper surface and a lower surface; (b) corona treating the substrate; (c) applying a release coating, if desired, onto the lower surface of the substrate using an aqueous solvent as a vehicle, and then drying the release coating; (d) applying an adhesive layer onto the upper surface of the substrate using an aqueous solvent as a vehicle, and then drying the adhesive layer, the adhesive layer itself having an upper surface; and (e) applying an overprinted release onto the upper surface of the adhesive layer using an aqueous solvent as a vehicle, and then drying the overprinted release.

In yet another aspect, the present invention provides a process for manufacturing a food grade wrap film comprising: (a) producing a substrate having upper and lower surfaces, wherein the upper surface is made up of an extruded pressure-sensitive adhesive layer that contains an amount of tackifier to render the extruded pressure-sensitive adhesive tacky; (b) overprinting a food-grade release onto the upper surface of the adhesive, wherein the release is overprinted in a discontinuous and repeating pattern, such that the overprinted release on the adhesive creates a plurality of non-tacky peaks and the absence of the overprinted release on the adhesive creates a plurality of valleys wherein the adhesive is exposed, the exposed adhesive in such valleys being protected by the peaks until such time as pressure is applied to said film during use; and (c) optionally disposing a release coating onto the lower surface of the substrate.

### BRIEF DESCRIPTION OF THE DRAWINGS

FIG. 1 shows a schematic cross-sectional view of an embodiment of the food grade wrap film of the present invention;

FIG. 2 shows a schematic top view of an embodiment of the food grade wrap film of the present invention;

FIG. 3 shows a schematic side view of yet another embodiment of the food grade wrap film of the present invention; and

FIG. 4 shows a schematic side view of yet a third embodiment of the food grade wrap film of the present invention.

### DETAILED DESCRIPTION OF THE INVENTION

This invention relates to a flexible, pressure-sensitive food grade wrap film comprising a substrate overcoated with a pressure-sensitive adhesive, and a release overprinted on the adhesive and comprising a dry resin pattern that prevents the adhesive from clinging to the surface of an article or to itself without applying pressure. Once pressure is applied to the film, the film flexibility allows the adhesive to contact the surface of the article or itself and subsequently adhere to hold the film in place or to form a sealed pouch around an article. The pressure-activated contact and adhesion to an article or to itself is designed to form a tight, spill-resistant bond that seals liquid or solid contents in a container, or forms a sealed pouch around a solid article.

Preferably, the upper and lower surfaces of each of the substrate and the pressure-sensitive adhesive are unitary. By “unitary” we mean that these surfaces are themselves substantially flat (i.e., free of embossing, raised areas or other such three-dimensional modifications). It is on such unitary surfaces that we can then more easily apply an overprinted release, for example.

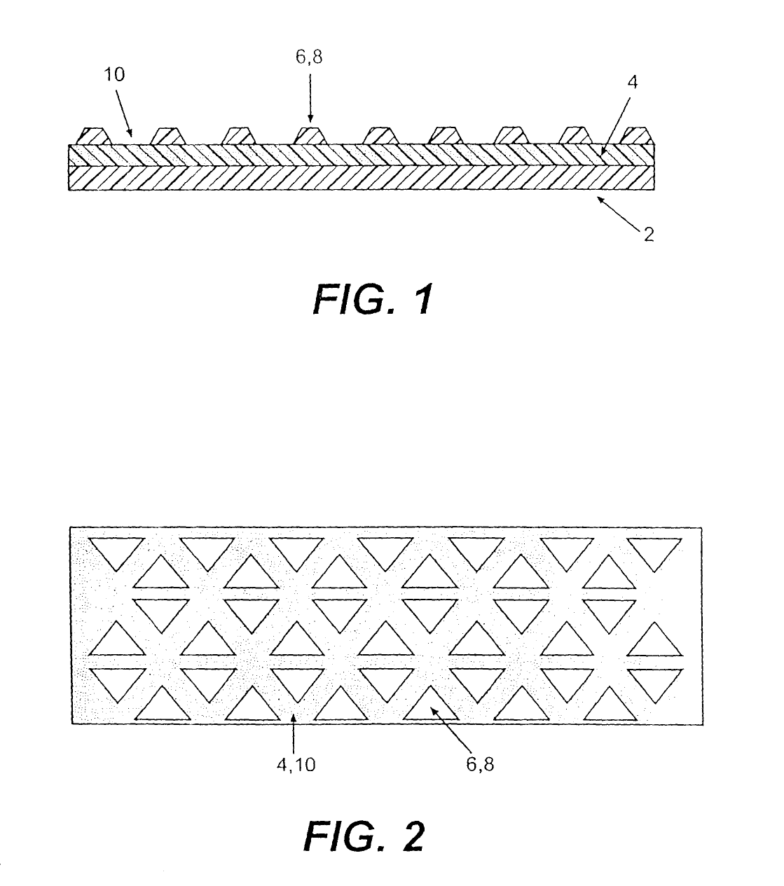

FIG. 1 depicts a schematic cross-sectional view of an embodiment of the food grade wrap film of the present invention. Substrate 2 has disposed thereon a pressure-sensitive adhesive 4. A release 6 is overprinted on the upper surface of the adhesive in a discontinuous and repeating pattern. The overprinted release 6 on the adhesive 4 creates a plurality of non-tacky peaks 8 and the absence of the overprinted release on the adhesive creates a plurality of valleys 10 wherein the adhesive 4 is exposed, the exposed adhesive 4 in such valleys 10 being protected by the peaks 8 until such time as pressure is applied to the film.

We believe that, when pressure is applied to the film, the substrate 2 and the adhesive 4, both of which are flexible, bend around the overprinted release 6. Furthermore, the overprinted release 6 is compressed into the adhesive 4. This causes the adhesive 4 to come into direct contact with the article being wrapped or covered. As noted above, the pressure-activated contact and adhesion to an article or to itself forms a tight, spill-resistant physical bond that retains liquid or solid contents in a container, or forms a pouch around a solid article.

FIG. 2 shows a schematic top view of an embodiment of the food grade wrap film. From this view, the overprinted release 6 is seen on the adhesive 4. An example of a suitable discontinuous and repeating pattern of the release 6 can be seen in this figure. The release 6 forms the peaks 8 and the exposed adhesive 4 forms valleys 10. Although FIG. 2 shows a discontinuous and repeating pattern of triangles, it should be noted that any other type of shape could be used for this pattern (e.g., circles, squares, diamonds, stars, etc.). Furthermore, more irregular shapes could conceivably be used as long as there is a sufficient concentration of peaks 8 to protect the adhesive 4 from contacting itself or other objects while no pressure is being applied. Different arrangements of shapes also are possible. However, if a spill-resistant seal around a covered object is desired once the film is pressed into place, it would be preferable for the overprinted release 6 to contain a pattern of shapes, wherein each “peak” defining a shape is surrounded on all sides by a “valley” of exposed adhesive. This type of arrangement will minimize conduits of leakage within the film. For example, it would be less desirable to have straight ridges of overprinted release 6 running along the film width-wise or length-wise since this type of arrangement might lead to a more leaky food-grade wrap film.

The substrate 2 can be made of any flexible polymer as long as it satisfies the Food and Drug Administration (FDA) direct food contact regulations or similar regulations issued in other countries (i.e., it is a “food grade substrate”). The substrate 2 can consist of one or more layers. Preferably, the substrate 2 can be made of modified polyolefins. High modulus materials such as polypropylene, high density polyethylene (HDPE), polyvinylidene vinyl chloride (PVDC or “Saran”), and polyvinyl chloride can comprise one of the layers of the substrate 2. A high modulus material reduces the tendency for the film to tangle, and tends to correlate with easy tearing of the film, making it easy to cut and dispense. Toughening materials such as low density polyethylene (LDPE), linear low density polyethylene (LLDPE), blends of LDPE and LLDPE, and ethylene vinyl acetate (EVA) can comprise another layer of the substrate 2. A toughening material prevents the film from tearing or splitting when trying to handle the material and, for example, unwrap the film from a container or object. It is believed that a layer of EVA, ethylene acrylic acid (EAA) or ethylene methacrylic acid (EMA) also helps the adhesive 4 to stick and prevents transfer of the adhesive 4 to food or containers, causing contamination. In a preferred embodiment, the substrate 2 comprises co-extruded HDPE and LDPE, or co-extruded HDPE, LDPE and polypropylene. In a most preferred embodiment, the substrate 2 comprises co-extruded HDPE, LDPE and EVA. Preferably, the substrate is corona-treated, as described further below.

The total thickness of the substrate 2 is between about 0.3 mils and about 1.5 mils, preferably between about 0.4 mils and about 0.9 mils, and most preferably between about 0.5 mils and about 0.8 mils. As used in this patent application, a “mil” is a unit of length, equal to 0.001 inch, or to 2.54×10⁻⁵ meter.

Furthermore, it is preferable for the substrate 2 to have certain Elmendorf tear properties and 2% secant modulus properties, and for the polymers, polymer blends or coextrusions used to manufacture the substrate 2 to be selected accordingly. In the transverse direction of the film, the Elmendorf tear property is a measure of how easy it will be to dispense a film by cutting it (e.g., with a cutter bar), and in the machine direction the Elmendorf tear property is a measure of how easy it will be for a film to avoid splitting. In the transverse direction (TD) of the substrate 2, preferably the degree of tearing will be between about 5 grams/mil and about 400 grams/mil, more preferably between about 20 grams/mil and about 200 grams/mil, and most preferably between about 50 grams/mil and about 150 grams/mil. In the machine direction (MD) of the substrate 2, preferably the degree of tearing will be between about 5 grams/mil and about 600 grams/mil, more preferably between about 20 grams/mil and about 400 grams/mil, and most preferably between about 50 grams/mil and about 200 grams/mil.

As suggested above, another useful way to measure the suitability of a material (or combination of materials) for use in the substrate 2 is to determine the substrate's 2% secant modulus (as measured by ASTM test method D882) (hereinafter “modulus”). Modulus can be measured in units of pounds per square inch (psi), and is a measure of a material's flexibility or stiffness. Preferably, the modulus of the substrate 2 is between about 20,000 psi and about 100,000 psi, more preferably between about 40,000 psi and about 80,000 psi, and most preferably between about 50,000 psi and about 70,000 psi.

The pressure-sensitive adhesive 4 must be an adhesive that complies with the FDA direct food contact regulations or similar regulations issued in other countries (i.e., it is a food grade pressure-sensitive adhesive). The adhesive 4 may be, for example, a polymeric acrylic emulsion, an emulsion or solvent acrylic, an emulsion or solvent tackified styrene-butadiene rubber adhesive, a solvent or hot melt tackified styrene block copolymer adhesive, a solvent or hot melt tackified EVA adhesive, a vinyl acetate ethylene emulsion, or blends of these materials. In a most preferred embodiment, the adhesive 4 comprises a polymeric acrylic emulsion (e.g., JonBond 743 available from S. C. Johnson Polymer, Racine, Wis.).

The adhesive 4 may have a unit weight of between about 0.5 grams per square meter and about 5.2 grams per square meter, preferably between about 1.2 grams per square meter and about 4.3 grams per square meter, most preferably between about 1.6 grams per square meter and about 3.2 grams per square meter. The thickness of the adhesive 4 may vary at different locations due to discontinuities in the coating. However, generally, the dry adhesive 4 will have a thickness of between about 0.02 mils and about 0.22 mils, preferably between about 0.05 mils and about 0.18 mils, most preferably between about 0.07 mils and about 0.14 mils.

The overprinted release 6 may be made of any water or solvent-based resin that exhibits good abrasion and water resistance, has non-tacky and non-blocking properties, and that conforms to the FDA direct food contact regulations or similar regulations in other countries (i.e., it is a food grade overprinted release). Examples of types of materials that may satisfy these requirements are hydrocarbon wax resins, polyvinyl alcohol-based resins, and polyurethane resins, or blends of these materials. Preferably, the overprinted release 6 is made of a water-based styrene acrylate resin (e.g., HRC 1645 available from S. C. Johnson Polymer, Racine, Wis.).

The coverage of the overprinted release 6 can be between about 10% and about 90%, and preferably between about 40% and about 80% of the adhesive layer 4, depending on the tack level and coating weight of the adhesive used. Most preferably, the overprinted release can cover approximately 70% of the adhesive layer 4. The range of coverage of the adhesive will depend on its tackiness.

The overprinted release 6 may have a unit weight of between about 0.5 grams per square meter and about 5.2 grams per square meter, preferably between about 1.2 grams per square meter and about 4.3 grams per square meter, most preferably between about 1.6 grams per square meter and about 3.2 grams per square meter. The thickness of the release 6 may vary at different locations due to discontinuities in the coating. However, generally, the dry release 6 will have a thickness of between about 0.03 mils and about 0.6 mils, preferably between about 0.2 mils and about 0.4 mils, most preferably between about 0.25 mils and about 0.35 mils. By controlling the thickness of the release (i.e., by not making the peaks of the release too high) or the spacing of the pattern elements, we have found that we can make the food grade wrap film easier to use since less pressure is required to cause the film to seal to itself and/or the object on which it has been placed. However, too thin a release is not desirable since this will increase blocking problems with the film.

In one embodiment, the substrate 2 preferably can be produced by a cast film process or a blown extrusion process. The cast film process is the most preferred method of producing the substrate because, by this method, it is easier to create the film (i.e., control the film's properties). The property of the substrate that is more easily controlled by the cast film process is the gauge variation, which we understand to mean the thickness of the film as it is measured along the width or web of the film. That is, we can more easily maintain the gauge variation of the substrate within the preferred thickness ranges mentioned earlier using a cast film process (as opposed to the blown extrusion process). Controlling the gauge variation in the substrate during the blown extrusion process can become a particular challenge as the substrate becomes thinner. This is because the degree of variation is fixed and becomes a greater percentage of the width of the object being extruded as the object becomes thinner. The cast film process for producing the substrate is also more preferred because, as the substrate is produced and wound up at the end of the line, it is easier to control the tension of the wound substrate, and hence, the degree of blocking that might occur. The lower gauge variation of the cast-film-produced substrate also improves web handling during the coating process and reduces wrinkles in the mill roll. (Mill rolls with excessive wrinkles cannot be easily separated or “slit” down into master rolls. Master rolls have the same width as consumer rolls but significantly more linear feet.)

Preferably, the substrate 2 is corona treated once it is produced. This is done to create a better contact surface on the substrate which makes it easier to subsequently apply additional layers, particularly the adhesive, onto the substrate. Accordingly, it is preferable to corona-treat any side of the substrate 2 on which will be applied another layer (e.g., an adhesive or a release coating). Most preferably, the upper surface on which an adhesive is applied will be corona treated. Corona treating ionizes the substrate and burns off the debris from the surfaces of the substrate to create consistent substrate surfaces without dust or dirt. If the substrate is produced, corona treated, and then not used immediately thereafter in manufacturing the food grade wrap film, it is preferable to “bump treat” the substrate, essentially by corona treating the substrate again in the manufacturing line immediately prior to its use. Preferably, the treatment level of the film should be between about 38 and about 46 dynes, more preferably between about 40 and about 44 dynes. Corona treating can bring the substrate to these dyne levels. Over time, the dyne level in the film can, for example, drop to about 36 dynes. By bump treating the film, the dyne level can be “bumped” back up to preferable treatment levels. A dyne is a measure of the surface tension of the substrate. Higher readings denote a more wettable surface for bonding of, for example, the adhesive layer.

Thereafter, the adhesive layer 4 preferably can be produced by casting the adhesive from an aqueous or organic-based solvent vehicle onto the substrate using a direct gravure coating process. A chrome coated anilox roll preferably can be used to deposit the correct wet coating weight of adhesive. We have found that the level of adhesive used is such that a normal printing press can be used for the manufacture of the film. Use of a printing press is preferable due to economic variables; however, a coater could also optionally be used. The adhesive 4 preferably can then be dried at about 180 [symbol] F.±20 [symbol] F. The overprinted release 6 preferably is applied directly to the adhesive 4 using a direct gravure process that employs an etched cylinder. The cylinder preferably is a chrome-plated cylinder that has been etched with shapes (e.g., such as triangular groups of cells that are spaced approximately 0.012″ apart at the parallel bases and about 0.064″ apart at the apexes). The depth of the cells can be approximately 75 microns, but may be between about 50 and about 100 microns, depending on the viscosity and solidity of the material used for the release 6. The overprinted release 6 preferably can then be dried at about 180 [symbol] F.±20 [symbol] F. Thus, a two-station press could be used, for example, to manufacture the pressure-sensitive food grade wrap film of this invention.

As the food grade wrap film is made along a manufacturing line, it is preferably then wound, at the end of the coating process, onto an accumulation roll called a mill roll. Most preferably, variable or taper tension is used to wind the film onto the mill roll. By this method, there is less tension on the film at the core. This is desirable since less blocking of the film will occur that could render the film at the core unusable. Preferably, the variable or taper tension should be set at between about 20% and about 30%. Most preferably, the variable or taper tension should be set at about 25%. The percentage of variable or taper tension refers to the tension at which the roll is wound by the machine. A variable or taper tension of a certain percentage describes a reduction of winding tension from the start of the roll (i.e., the core) to the end of the roll. For example, if the winding tension at the core is at a 10 lb-force, the tension used at the outside diameter would be at a 2.5 lb-force. The variable tension in such a situation would be 25%. In order to set the variable tension, the outside diameter of the roll must be known at the beginning of the process and inputted into the machine at this point.

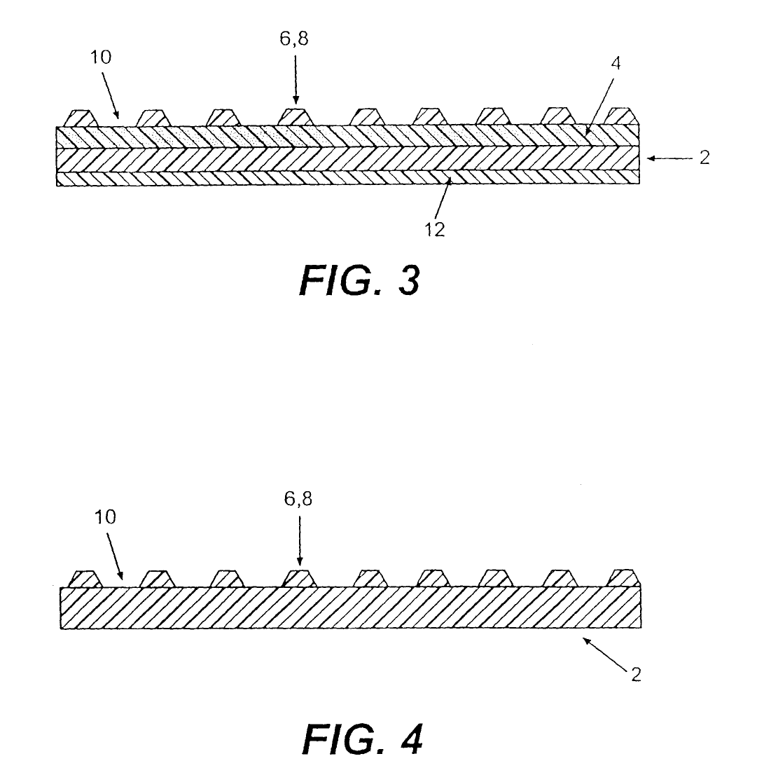

In an alternative embodiment, the food grade wrap film can additionally comprise a release coating 12 disposed on the surface of the substrate 2 opposite from the adhesive 4, as shown in FIG. 3. This additional release coating 12 can provide further protection to the food grade wrap film against the film blocking (i.e., sticking to itself) to facilitate the unwinding of the film by consumers. This release-coating is also helpful during the manufacture of the film since it facilitates the slitting process, namely, the process by which a mill roll is reduced (or separated) into multiple master rolls.

This release coating 12 can be made of silicones or carbamates, for example, as long as the substance used conforms with the FDA direct food contact regulations or similar regulations in other countries (i.e., it is a food grade release coating). Preferably, this release coating 12 can comprise a fluorinated copolymer delivered from a water and alcohol blend (e.g., perfluoroalkyl phosphate (also known as Mayzo RA-120W available from Mayzo, Inc.)). Alternatively, this release coating 12 can comprise an aqueous silicone, an ultraviolet-cured solventless silicone material, or an electron-beam-cured solventless silicone material. The coating 12 is preferably applied using a direct gravure process using a chrome plated anilox roll, in a dry weight of between about 0.1 grams per square meter and about 0.5 grams per square meter. It is preferably dried at about 180 [symbol] F.±20 [symbol] F.

Alternatively, release agents can be added directly to the substrate during film extrusion, preferably in a lower surface layer of the substrate, such that the food grade -wrap film contains: (a) a food-grade substrate having an upper surface, wherein the substrate contains an amount of a release agent (also referred to as an antiblock agent), preferably in the lower surface layer of the substrate; (b) a food grade pressure-sensitive adhesive disposed on the upper surface of the film and itself having an upper surface; and (c) a food grade release overprinted on the upper surface of the adhesive in a discontinuous and repeating pattern, such that the overprinted release on the adhesive creates a plurality of non-tacky peaks and the absence of the overprinted release on the adhesive creates a plurality of valleys wherein the adhesive is exposed, the exposed adhesive in such valleys being protected by the peaks until such time as pressure is applied to the film. The following release agents could be used in this alternative embodiment, by way of example: diatomaceous earth, precipitated silica, amorphous silica, fatty amides, ceramic spheres, calcium carbonate and talc.

In yet another embodiment, the food grade wrap film illustrated in FIGS. 1 and 2 can contain a pigmented substrate 2, a pigmented adhesive 4 and/or a pigmented overprinted release 6.

In yet another embodiment, a logo can be printed onto the film, preferably on the surface of the substrate 2 opposite from the adhesive 4. Furthermore, it is preferable that, if both a release coating 12 and a logo are to be applied to the film, then the logo should be printed first and the release coating 12 should be applied thereafter to the surface of the substrate 2 opposite the adhesive 4. Alternatively, the logo can be incorporated into the pattern of the overprinted release 6 which would alleviate the additional step of printing a logo onto the film. The logo can assist consumers in identifying the manufacturing source of the film. It also can provide an indication of the directionality of the film so that the consumer can easily identify the side of the film with the adhesive 4.

In order to accommodate the various embodiments described above, a three or four-station press could be used to manufacture the pressure-sensitive food grade wrap film of this invention. The additional stations could be used to apply an additional release coating onto the lower surface of the film and/or to print a logo onto the film.

Most preferably, the food grade wrap film of this invention is manufactured in several steps. First, the substrate must be produced and preferably corona treated. Later, prior to applying various additional layers to the substrate, the substrate can be bump treated on both sides. Thereafter, a release coating, if desired, can be applied on the lower surface of the substrate. The release coating can then be applied using an aqueous or an organic-based solvent as a vehicle. Most preferably, an aqueous-based system is used, in order to ensure that the process used to manufacture the product is environmentally friendly. Following wet application of the release coating on the lower surface of the substrate, the release coating can be dried. Thereafter, the adhesive layer can be added using an aqueous or an organic-based solvent as a vehicle. Again, the film can be dried following application of the adhesive layer on the upper surface of the substrate. Finally, the overprinted release can be applied to the upper surface of the adhesive layer, also using an aqueous or an organic-based solvent as a vehicle. Again, upon application of the overprinted release, the food grade wrap film that has been produced can be dried.

Most preferably, an aqueous-based system is used to apply the various layers, onto the substrate to produce the food grade wrap film. Each applied layer can then be dried. In some specific cases, both the adhesive and the overprinted release can be wet applied and dried at the same time.

Most preferably, first, a radio frequency dryer and, second, a high energy (or low temperature set) convection oven are used to dry the film at each step of its production. Another way to dry the film at each stage of its production would be to use a low temperature set convection oven followed by a high temperature set convection oven. If this second drying method is used, it would be more preferable to use it only when drying the applied overprinted release and release coating, if one is used, but not when drying the adhesive, at which point a radio frequency dryer could be used, followed by a high temperature set convection oven. The benefit of using a radio frequency dryer is that the energy is focused on the water rather than the film. If one uses convection ovens, the film ends up being heated, and this causes the film to stretch, making the film less uniform, and harder to handle and to coat appropriately. These additional problems then reduce the speed at which the film can be manufactured. Radio frequency drying concentrates the heating energy only on the water molecules because this method allows only certain molecules in a certain radio frequency range to be excited. As a result, the film is dried from the inside-out. On the contrary, a high-temperature set convection oven will dry the film from the outside-in. This can sometimes become problematic if a “skin” is produced because the outside of a layer becomes dry, whereas the inside remains wet. By analogy, this occurs on occasion, for example, with drying paint. However, when both the radio-frequency drying method is combined with the high temperature convection drying method, the ideal combination of drying inside-out and then outside-in is achieved. This most preferred method reduces the likelihood of the film being over-heated and stretched during production. Consequently, a better product can be produced since there is less likely to be variability in the film.

In yet another alternative embodiment, as shown in FIG. 4, there is provided a food grade wrap film that includes: (1) a food-grade substrate 2 having upper and lower surfaces, wherein the upper surface is made up of an extruded pressure-sensitive adhesive layer (sometimes referred to as a hot-melt or hot-melt adhesive) that contains an amount of tackifier to render the extruded pressure-sensitive adhesive tacky; and (2) a food grade release 6 overprinted on the upper surface of the substrate 2 in a discontinuous and repeating pattern, such that the overprinted release 6 on the substrate 2 creates a plurality of non-tacky peaks 8 and the absence of the overprinted release 6 on the substrate 2 creates a plurality of valleys 10 wherein the substrate 2 is exposed, the exposed substrate 2 in such valleys 10 being protected by the peaks 8 until such time as pressure is applied to said film. The possible components for the substrate 2 and overprinted release 6 of the embodiment described earlier can also be used in this alternative embodiment. Preferably, the extruded pressure-sensitive adhesive is ethylene vinyl acetate (EVA), and the tackifier is poly-iso-butylene (PIB). Preferably, in the EVA base polymer, there should be between about 10 weight percent and about 40 weight percent vinyl acetate, more preferably between about 15 weight percent and about 35 weight percent vinyl acetate, and most preferably between about 28 weight percent and about 33 weight percent vinyl acetate. The amount of tackifier to render the extruded pressure-sensitive adhesive tacky is preferably between about 0% and about 50% by weight of the extruded pressure-sensitive adhesive. Most preferably, the substrate can contain coextruded HDPE, LDPE and EVA containing PIB as a tackifier. Although EVA without tackifier does tend to stick to glass, for example, the addition of tackifier renders EVA tacky as to other substances, such as pottery or polypropylene.

Optionally, a release coating 12 (not shown in FIG. 4 but discussed earlier with regard to a different embodiment and illustrated in FIG. 3), can be disposed on the lower surface of the substrate 2 (i.e., the substrate 2 surface opposite to which the overprinted release 6 is disposed).

This additional alternative embodiment of the invention preferably can be produced in several steps. First, the substrate can be produced by a cast film process or a blown extrusion process. Thereafter, either a direct gravure process, as previous discussed, or a printing process can be used to apply the overprinted release.

### Industial Applicability

The present invention provides a material useful as a food grade wrap film and a process for manufacturing it. We envision that this food grade wrap film preferably can be used to wrap foods, containers and any other objects when enhanced cling without excessive blocking is desired in the film.

While particular embodiments of the present invention have been illustrated and described, it will be apparent to those skilled in the art that various changes and modifications may be made without departing from the spirit and scope of the invention. Furthermore, it is intended that the claims will cover all such modifications that are within the scope of the invention.

We claim:

1. A food grade wrap film comprising:
(a) a food grade substrate having an upper surface and a lower surface;
(b) a food grade pressure-sensitive adhesive disposed on the upper surface of said substrate, and itself having an upper surface; and
(c) a food grade release overprinted on the upper surface of said adhesive in a discontinuous and repeating pattern, such that said overprinted release on said adhesive creates a plurality of non-tacky peaks and the absence of said overprinted release on said adhesive creates a plurality of valleys wherein the adhesive is exposed, the exposed adhesive in such valleys being protected by the peaks until such time as pressure is applied to said film.

2. The film of claim 1, wherein said substrate has a degree of tearing in the transverse direction (TD) of between about 5 grams/mil and about 400 grams/mil, a degree of tearing in the machine direction (MD) of between about 5 grams/mil and about 600 grams/mil and a modulus of between about 20,000 psi and about 100,000 psi.

3. The film of claim 1, wherein said substrate is comprised of a coextrusion of HDPE and LDPE.

4. The film of claim 1, wherein said substrate is comprised of a coextrusion of HDPE, LDPE and EVA.

5. The film of claim 1, wherein the substrate is corona-treated.

6. The film of claim 4, wherein the substrate is corona-treated.

7. The film of claim 1, wherein said substrate is comprised of a coextrusion of HDPE, LDPE and polypropylene.

8. The film of claim 1, wherein said pressure-sensitive adhesive comprises a material selected from the group consisting of: a polymeric acrylic emulsion, an emulsion or solvent acrylic, an emulsion or solvent tackified styrene-butadiene rubber adhesive, a solvent or hot melt tackified styrene block copolymer adhesive, a solvent or hot melt tackified EVA adhesive, a vinyl acetate ethylene emulsion, and blends of two or more of these materials.

9. The film of claim 1, wherein said overprinted release comprises a styrene acrylate resin.

10. The film of claim 1, wherein the thickness of said substrate is between about 0.3 mils and about 1.5 mils.

11. The film of claim 1, wherein the thickness of said substrate is between about 0.4 mils and about 0.9 mils.

12. The film of claim 1, wherein the thickness of said substrate is between about 0.5 mils and about 0.8 mils.

13. The film of claim 1, wherein said adhesive has a unit weight of between about 0.5 grams per square meter and about 5.2 grams per square meter.

14. The film of claim 1, wherein the thickness of said adhesive is between about 0.02 mils and about 0.22 mils.

15. The film of claim 1, wherein the thickness of said adhesive is between about 0.05 mils and about 0.18 mils.

16. The film of claim 1, wherein the thickness of said adhesive is between about 0.07 mils and about 0.14 mils.

17. The film of claim 1, wherein said overprinted release has a unit weight of between about 0.5 grams per square meter and about 5.2 grams per square meter.

18. The film of claim 1, wherein the thickness of said overprinted release is between about 0.03 mils and about 0.6 mils.

19. The film of claim 1, wherein the thickness of said overprinted release is between about 0.2 mils and about 0.4 mils.

20. The film of claim 1, wherein the thickness of said overprinted release is between about 0.25 mils and about 0.35 mils.

21. The film of claim 1, further comprising a food grade release coating disposed on the lower surface of said substrate.

22. The film of claim 21, wherein said release coating comprises a material selected from the group consisting of: a fluorinated copolymer delivered from a water and alcohol blend, an aqueous silicone, an ultraviolet-cured solventless silicone material, and an electron-beam-cured solventless silicone material.

23. The film of claim 21, wherein said release coating has a unit weight of between about 0.1 grams per square meter and about 0.5 grams per square meter.

24. The film of claim 1, wherein said adhesive comprises a pigment.

25. The film of claim 1, wherein the overprinted release comprises a pigment.

26. The film of claim 1, wherein the pattern in the overprinted release covers about 70% of the upper surface of said adhesive.

27. The film of claim 1, wherein the pattern in the overprinted release covers between about 10% and about 90% of the upper surface of said adhesive.

28. A food grade wrap film comprising:
(a) a food grade substrate having an upper surface and a lower surface, wherein the upper surface comprises an extruded pressure-sensitive adhesive layer that contains an amount of tackifier to render the extruded pressure-sensitive adhesive layer tacky; and
(b) a food grade release overprinted on the upper surface of said substrate in a discontinuous and repeating pattern, such that said overprinted release on said substrate creates a plurality of non-tacky peaks and the absence of said overprinted release on said substrate creates a plurality of valleys wherein said substrate is exposed, said exposed substrate in such valleys being protected by the peaks until such time as pressure is applied to said film.

29. The film of claim 28, wherein the extruded pressure-sensitive adhesive is EVA.

30. The film of claim 29, wherein the tackifier is PIB.

31. The film of claim 29, wherein the substrate further comprises HDPE and LDPE.

32. A food grade wrap film comprising:
(a) a food-grade substrate having an upper surface, wherein the substrate contains an amount of a release agent;
(b) a food grade pressure-sensitive adhesive disposed on the upper surface of said substrate, and itself having an upper surface; and
(c) a food grade release overprinted on the upper surface of said adhesive in a discontinuous and repeating pattern, such that said overprinted release on said adhesive creates a plurality of non-tacky peaks and the absence of said overprinted release on said adhesive creates a plurality of valleys wherein the adhesive is exposed, the exposed adhesive in such valleys being protected by the peaks until such time as pressure is applied to the film.

33. A flexible, food grade wrap film comprising:
(a) a flexible, food grade substrate having unitary upper and lower surfaces;
(b) a flexible, food grade pressure-sensitive adhesive substantially continuously disposed on the entire upper surface of said substrate, and itself having a unitary upper surface; and
(c) a flexible, food grade release overprinted on the upper surface of said adhesive in a discontinuous and repeating pattern, such that said overprinted release on said adhesive creates a plurality of non-tacky peaks and the absence of said overprinted release on said adhesive creates a plurality of valleys wherein the adhesive is exposed, the exposed adhesive in such valleys being protected by the peaks until such time as pressure is applied to said film.

34. A flexible, food grade wrap film comprising:
(a) a flexible, food grade substrate having unitary upper and lower surfaces, wherein the upper surface comprises an extruded pressure-sensitive adhesive layer that contains an amount of tackifier to render the extruded pressure-sensitive adhesive layer tacky; and
(b) a flexible, food grade release overprinted on the upper surface of said substrate in a discontinuous and repeating pattern, such that said overprinted release on said substrate creates a plurality of non-tacky peaks and the absence of said overprinted release on said substrate creates a plurality of valleys wherein said substrate is exposed, said exposed substrate in such valleys being protected by the peaks until such time as pressure is applied to said film.

35. A flexible, food grade wrap film comprising:
(a) a flexible, food-grade substrate having unitary upper and lower surfaces, wherein the substrate contains an amount of a release agent;
(b) a flexible food grade pressure-sensitive adhesive substantially continuously disposed on the entire upper surface of said substrate, and itself having a unitary upper surface; and
(c) a flexible, food grade release overprinted on the upper surface of said adhesive in a discontinuous and repeating pattern, such that said overprinted release on said adhesive creates a plurality of non-tacky peaks and the absence of said overprinted release on said adhesive creates a plurality of valleys wherein the adhesive is exposed, the exposed adhesive in such valleys being protected by the peaks until such time as pressure is applied to the film.

36. A process for manufacturing a food grade wrap film comprising:
(a) producing a substrate having an upper surface and a lower surface;
(b) applying a food-grade pressure sensitive adhesive to the upper surface of the substrate; and
(c) overprinting a food-grade release onto the upper surface of the adhesive, wherein the release is overprinted in a discontinuous and repeating pattern, such that the overprinted release on the adhesive creates a plurality of non-tacky peaks and the absence of the overprinted release on the adhesive creates a plurality of valleys wherein the adhesive is exposed, the exposed adhesive in such valleys being protected by the peaks until such time as pressure is applied to said film during use.

37. The process of claim 36, wherein the substrate is produced in step (a) using a cast film process or a blown extrusion process.

38. The process of claim 36, wherein the substrate is produced in step (a) using a cast film process.

39. The process of claim 36, further comprising, between steps (a) and (b), an additional step (a.1) of corona treating the substrate.

40. The process of claim 39, wherein, after step (a.1), the treatment level of the film is between about 38 and about 46 dynes.

41. The process of claim 36, wherein the adhesive in step (b) is applied by casting the adhesive from an aqueous or organic-based solvent vehicle onto the substrate using a direct gravure coating process.

42. Tie process of claim 36, wherein the food-grade release in step (c) is overprinted onto the upper surface of the adhesive using a direct gravure process that employs an etched cylinder.

43. The process of claim 36, further comprising, after step (c), an additional step (c.1) of drying the overprinted release at about 180 [symbol] F.±20 [symbol] F.

44. The process of claim 36, further comprising, after step (c), an additional step (d) of winding the film onto a roll at a variable tension set between about 20% and about 30%.

45. The process of claim 36, wherein the substrate produced in step (a) contains release agents.

46. The process of claim 36, further comprising a step (d) of disposing a release coating onto the lower surface of the substrate.

47. The process of claim 36, further comprising a step (d) of printing a logo onto a surface of the substrate.

48. The process of claim 47, further comprising, after step (d), a step (e) of disposing a release coating onto the lower surface of the substrate.

49. A process for manufacturing a food grade wrap film comprising:
(a) producing a substrate having an upper surface and a lower surface;
(b) corona treating the substrate;
(c) applying a release coating, if desired, onto the lower surface of the substrate using an aqueous solvent as a vehicle, and then drying the release coating;
(d) applying an adhesive layer onto the upper surface of the substrate using an aqueous solvent as a vehicle, and then drying the adhesive layer, the adhesive layer itself having an upper surface; and
(e) applying an overprinted release onto the upper surface of the adhesive layer using an aqueous solvent as a vehicle, and then drying the overprinted release.

50. The process of claim 49, wherein the release coating in step (c), the adhesive layer in step (d), and the overprinted release in step (e) are dried using a radio frequency dryer followed by a high temperature convection oven.

51. A process for manufacturing a food grade wrap film comprising:
(a) producing a substrate having upper and lower surfaces, wherein the upper surface is made up of an extruded pressure-sensitive adhesive layer that contains an amount of tackifier to render the extruded pressure-sensitive adhesive tacky; and
(b) overprinting a food-grade release onto the upper surface of the adhesive, wherein the release is overprinted in a discontinuous and repeating pattern, such that the overprinted release on the adhesive creates a plurality of non-tacky peaks and the absence of the overprinted release on the adhesive creates a plurality of valleys wherein the adhesive is exposed, the exposed adhesive in such valleys being protected by the peaks until such time as pressure is applied to said film during use.

52. The process of claim 51, further comprising a step (c) of disposing a release coating onto the lower surface of the substrate.
